(19) United States
(12) Patent Application Publication
(10) Pub. No.: US 2007/0162159 A1
(43) Pub. Date: Jul. 12, 2007

(54) METHOD FOR MODIFICATION OF A NUMBER OF PROCESS CONTROL PROTOCOLS

(76) Inventor: Karin Ladenburger, Erlangen (DE)

Correspondence Address: SCHIFF HARDIN, LLP;PATENT DEPARTMENT, 6600 SEARS TOWER, CHICAGO, IL, 60606-6473, US

(21) Appl. No.: 11/615,186

(22) Filed: Dec. 22, 2006

(30) Foreign Application Priority Data
Dec. 23, 2005 (DE) 10 2005 061 796.4

(51) Int. Cl. G05B 11/01

(52) U.S. Cl. 700/17

(57) ABSTRACT

A method for modification of a number of process control protocols of a set of defined process control protocols for control of a medical-technical system is provided. Within a modification process protocol selection signals are thereby detected for selection of a number of process control protocols with regard to which a modification action is to be implemented; the control parameters that can be changed in the selected process control protocols are thereupon displayed and parameter values are detected according to which the control parameters are to be changed in the selected process control protocols. A display of the changes to be implemented in the selected process control protocols within the modification process then ensues. After detection of an acknowledgement signal the automatic implementation of the modifications ensues with regard to the selected process control protocols. Moreover, a method for modification of a set of defined process control protocols is described in which an action signal for selection of a specific modification action is initially detected and then a modification process is selected (dependent on the selected modification action) from a number of predefined modification processes. A workflow of the selected modification process is then initiated and further modification specification signals are detected within this modification process, according to which modification specification signals the modifications are implemented. Moreover, a corresponding protocol modification unit and a protocol set modification device are described.

### BACKGROUND OF THE INVENTION

1. Field of the Invention

The present invention relates generally to a method and a protocol modification unit for modification of a number of process control protocols of a set of defined process control protocols which respectively serve for activation of a medical-technical system for automatic implementation of examination processes. Furthermore, the invention concerns a method and a protocol set modification device for modification of a set of corresponding process control protocols. Moreover, the invention concerns a control device for an imaging medical-technical system for generation of patient image data with such a protocol modification unit and/or such a protocol set modification device, an imaging medical-technical system for generation of patient image data with a corresponding control device as well as a computer program product with which the aforementioned method can be implemented on a computer.

2. Description of the Related Art

Large-scale medical-technical devices, in particular modern imaging medical-technical systems such as computer tomographs, nuclear magnetic resonance tomographs, x-ray systems, ultrasound systems, angiographs and similar devices are extraordinarily complex systems. Such systems comprise a number of system components. These system components include various hardware components (such as data acquisition devices, cooling devices, control computers, and the like) and also include software components (such as various image evaluation software or applications with special monitoring and control processes). In order to be able to implement an examination of a patient with such a large-scale medical apparatus, a number of parameters must be set by the operator. For example, in a computer tomograph some of the parameters (such as, for example, the parameters mAs, pitch, and collimation) influence the dose and the image quality. In contrast to this, other parameters determine the progression of a workflow, such as, for example, the automatic transmission of the acquired image data to a workstation or to a PACS (Picture Archiving and Communication System). Other parameters determine the manner in which the raw image data should be reconstructed. Examples of such parameter data include the parameters “seed”, “increment” and “window value”.

Before the measurement can be implemented all of these parameters are typically established in a process control protocol, which is used when an automatic measurement is performed. The operator of the device may possibly call standard protocols (what are known as default scan protocols, and that are delivered along with the apparatus by the manufacturer of the apparatus) on a user interface at a control terminal of the large-scale apparatus. These standard protocols include preset parameters that are all necessary for a specific examination, such as, for example, an abdomen routine or three-phase liver examination given a computer tomography examination. The operator can change one or more of the parameters of the appertaining individual process control protocol using the user interface. The process control protocol which has now been altered by the user input can subsequently be stored with the altered values. However, with the current methods all of the parameters cannot be modified via this user interface. For changing the parameters that are beyond this user interface or in particular for changing a plurality of process control protocols simultaneously, there is at the moment only the possibility to have all protocols output in a complicated table form and to make changes within this table structure. The table structure is, however, unclear, such that each change is assessed as too complicated both by the “normal” operators and by the application trainers who are typically available for training of the operators on the large-scale apparatuses. Even if such a modification is made in such a complicated table form, the danger exists that errors can occur in the adjustment of the parameters.

In U.S. Pat. No. 6,603,494 B1, a method and a system are described in which various modalities can be operated with a universal graphical user interface, whereby identical parameters of the various modalities are shown identically or similarly in order to simplify the operation. However, this user interface allows only the selection and modification of specific parameters of individual protocols.

### SUMMARY OF THE INVENTION

The present invention provides the possibility that even less-proficient operators of complex devices, such as medical imaging devices or the like, can simultaneously modify an arbitrary number of process control protocols or, respectively, a complete set of such defined process control protocols in a simple and safe manner.

This is achieved via a method for modification of a number of process control protocols of a set of defined process control protocols (which respectively serve for control of a medical-technical system for implementation of examination processes) within a modification process with the following method steps:
detection of protocol selection signals for selection of a number of process control protocols with regard to which a modification action is to be implemented,
display of control parameters that can be changed in the selected process control protocols,
detection of parameter values according to which the control parameters are to be changed in the selected process control protocols,
display of the changes to be implemented in the selected process control protocols within the modification process, and
detection of an acknowledgement signal and automatic implementation of the modifications with regard to the selected process control protocols when a corresponding acknowledgement signal is detected.

For this an inventive method for modification of a number of process control protocols of a set of defined process control protocols (for example scan protocols (or, respectively, acquisition protocols) of an imaging system) comprises the following method steps that are run through within an advantageously menu-controlled modification process:
detection or recording of protocol selection signals (via a suitable user interface) for selection of a number of process control protocols with regard to which a modification action is to be implemented;
display of control parameters that can be changed in the selected process control protocols;
detection of parameter values according to which the control parameters are to be changed in the selected control protocols;
display of the changes to be implemented in the selected process control protocols within the modification process; and
detection of an acknowledgement signal and automatic implementation of the modification with regard to the selected process control protocols when a corresponding acknowledgement signal is detected.

The fundamental idea here is to initially select from the set of defined process control protocols all protocol selection signals with regard to which modifications are to be implemented at all. Only a single process control protocol or also all process control protocols (insofar as all of these should be changed) can hereby be selected. The modifiable control parameters are then respectively displayed only for the relevant selected process control protocols. This means that all control parameters for all process control protocols are not displayed in a comprehensive table (as previously typical). The modification of the process control protocols is hereby significantly clearer for the operator. The modifications provided by the operator are then additionally displayed and a further acknowledgement signal must ensue before these are actually implemented. Overall this leads to the situation at even a non-proficient operator can modify the process control protocols relatively simply with very low risk of operation error and can thus control the large-scale medical apparatus according to his desires. Via the better clarity within the modification process and the additional display and input of an acknowledgement signal, the operator has the assurance that precisely the modifications intended by him are implemented and that unintended additional changes that could lead to a poorer work result (or, in the extreme case, to an additional exposure for a patient) have not been inserted.

The method for modification of a set of defined process control protocols further provides that a set of defined process control protocols which respectively serve for control of a medical-technical system for implementation of examination processes, in which an action signal for selection of a specific modification action is initially detected and then a modification process is selected (dependent on the selected modification action) from a number of predefined modification processes and a workflow of the selected modification process is initiated and further modification specification signals are detected within this modification process, according to which modification specification signals the modifications are implemented.

The present invention also provides a protocol modification unit for modification of a number of process control protocols of a set of defined process control protocols (which respectively serve for control of a medical-technical system for implementation of examination processes) within a defined modification process, whereby the protocol modification unit comprises the following modules respectively connected in communication:
a protocol selection detection module that is designated to detect protocol selection signals for selection of a number of process control protocols with regard to which a modification action is to be implemented,
a first display module that is designated to display control parameters that can be modified in the selected process control protocols,
a parameter value detection module that is designated to detect parameter values according to which the control parameters are to be modified in the selected process control protocols,
a second display module that is designated to display modifications that are to be implemented in the selected process control protocols within the modification process,
an acknowledgement signal detection module that is designated to detect an acknowledgement signal, and
a modification implementation module that is designated to automatically implement the changes with regard to the selected process control protocols when the acknowledgement signal detection module detects an acknowledgement signal.

An inventive protocol modification unit with which a number of process control protocols can correspondingly be modified comprises the following modules respectively connected in communication:
a protocol selection detection module that is designated to detect protocol selection signals for selection of a number of process control protocols with regard to which a modification action is to be implemented;
a first display module that is designated to display on a user interface control parameters that can be modified in the selected process control protocols;
a parameter value detection module that is designated to detect parameter values according to which the control parameters are to be modified in the selected process control protocols;
a second display module that is designated to display modifications that are to be implemented in the selected process control protocols within the modification process;
an acknowledgement signal detection module that is designated to detect an acknowledgement signal and
a modification implementation module that is designated to automatically implement the changes with regard to the selected process control protocols when the acknowledgement signal detection module detects an acknowledgement signal.

The advantages of the present invention are further achieved via a protocol set modification device for modification of a set of defined process control protocols which respectively serve for control of a medical-technical system for implementation of examination processes, whereby the protocol set modification device comprises the following modules respectively connected in communication:
a number of modification process implementation modules that are respectively designated to implement a specific modification action within a defined modification process, whereby further modification specification signals according to which the modification actions are implemented are detected within this modification process,
an action selection detection module that is designated to detect an action selection signal for selection of a specific modification action,
a process selection module that is designated to select a modification process implementation module from the number of modification process implementation modules dependent on the selected modification action and to put said modification process implementation module into operation.

### BRIEF DESCRIPTION OF THE DRAWINGS

FIG. 1 is a flow diagram for clarification of a possible workflow of an inventive method for modification of a set of defined process control protocols, including a method for modification of a number of process control protocols;

FIGS. 2 through 13 shows various examples for image screen displays for realization of a dialog for inventive modification of a set of defined process control protocols; and

FIG. 14 is a schematic block representation of an inventive medical-technical system with a control device on which the inventive method can be implemented

### DETAILED DESCRIPTION OF THE PREFERRED EMBODIMENTS

In preferred embodiments of the inventive protocol set modification set, an action selection signal is initially detected for selection of a determined modification action, i.e. a type of modification to be implemented. This can also occur again via a suitable user interface. Dependent on the modification action selected by the operator, a modification process for example a menu-controlled modification process is then selected by the operator from a number of pre-defined modification processes. A workflow of the selected modification process is then subsequently initiated, whereby further modification specification signals (for example protocol selection signals, new parameter values and the like) according to which the modifications are implemented are recorded within this modification process.

This modification process can, for example, be the method already described above in which the control parameter values are modified in a number of selected process control protocols. Moreover, however, this method also offers the possibility to effect other changes to a set of defined process control protocols such as, for example, to reset specific modified process control protocols to a standard state again, to add new standard protocols or to delete protocols.

A resetting of individual values within an unclear table or, respectively, a deletion or addition of table columns is then no longer necessary, rather, even such complex modifications can be implemented comfortably in a simple manner and therewith with reduced tendency of an operator towards error.

A corresponding inventive protocol set modification device comprises the following modules respectively connected in communication:
a number of modification process implementation modules that are respectively designated to implement a specific modification action within a defined modification process, whereby further modification specification signals according to which the modification actions are implemented are detected within this modification process;
an action selection detection module that is designated to detect an action selection signal for selection of a specific modification action and
a process selection module that is designated to select a modification process implementation module from the number of modification process implementation modules dependent on the selected modification action and to put said modification process implementation module into operation, i.e. to start the respective modification process implementation module.

The individual modules of the protocol modification unit and of the protocol set modification device are advantageously realized in the form of software components on a programmable computer, whereby such a computer can, for example, be a control device of an medical-technical system, and in a preferred example a medical imaging system. This has the advantage that already-existing control devices or, respectively, medical-technical systems can be retrofitted or upgraded in a simple manner. However, this does not preclude that parts of the protocol modification unit and/or of the protocol set modification device are also realized in hardware.

The modules can also comprise a plurality of sub-units or a plurality of the modules can also be linked to a common unit which administers the functions of the appertaining modules.

Further particularly advantageous embodiments and developments of the invention are provided by a method that further provides that a parameter type selection signal is initially detected for detection of the parameter values and control parameters belonging to a specific parameter type are offered to an operator for modification dependent on a detected parameter type selection signal.

In a further improvement of the method, a parameter type comprises control parameters of a scan process and/or image reconstruction process to be implemented with an imaging medical-technical system and in that a scan mode selection signal is detected for selection of process control protocols with regard to which the modification actions are to be implemented with which process control protocols an activation of the medical-technical system ensues in a specific scan mode.

In the method, an allowable value range of the appertaining control parameter is displayed to the operator for input of control parameter values when the opertor inputs an unacceptable value.

The preferred method provides that a relative parameter modification value is detected for a modifiable control parameter and a control parameter value belonging to this control parameter can then be modified relative to the currently applied parameter value according to the parameter modification value.

In a preferred method, a modification action comprises a modification of control parameter values in a number of process control protocols and the modifications are implemented within a modification process according to a method according to any of the foregoing aspects.

As a further development of the method, a modification action comprises a resorting of a display order of process control protocols within the set of defined process control protocols.

The method may also provide that a modification action comprises a reestablishment of predetermined standard process control protocols.

Additionally, a modified standard process control protocol is reset again to an original standard process control protocol or an original standard process control protocol is reestablished by leaving the modified standard process control protocol.

As yet another option, a modification action comprises an adoption of predefined process control protocols.

In one embodiment, a modification action comprises a deletion of process control protocols.

In yet another embodiment, the number of the method steps within a modification process to be run is shown to the operator and it is displayed in which of the method steps the modification process is currently located.

The process control protocols respectively serve for control of an imaging medical-technical system, for example.

Embodiments of the protocol set modification device are characterized in that a modification process implementation module comprises a protocol modification unit as set forth in the forgoing.

A control device is provided in one embodiment for a medical-technical system for generation of patient image data with a protocol modification unit according to the features set forth above.

A medical-technical system for generation of patient image data with a control device, such as the control device above, is provide in one embodiment.

A preferred example of the present invention provides a computer program product which can be directly loaded into a memory of a programmable computer, with program codes in order to execute all steps of a method according to the foregoing when the program is executed on the computer.

In a particularly preferred development of the method for modification of a number of process control protocols, a parameter type selection signal is initially detected for detection of the parameter values and the control parameters belonging to a specific parameter type are then offered to the operator for modification dependent on a detected parameter type selection signal. For example, given a process control protocol for a computer tomograph it can initially be determined by the operator (with the aid of the parameter type selection signal) whether the operator would like to modify parameter values that concern the protocol (such as, for example, the name of the protocol which body region it pertains to or in which direction the patient is positioned in the tomograph). Alternatively, the operator could determine that he or she would like to modify only the parameter values for the acquisition of what is known as a “topogram” (an overview image). The operator could likewise establish that he or she would like to modify the parameter values of the actual exposure (of the “scan”). Further possibilities are the selection of all parameters that pertain to the reconstruction of the images or all parameters that specify how the further workflow ensues after the generation of the images. Counting among these are, among other things, control parameters that establish whether an auto-filming or auto-imaging is implemented and whether the images are automatically sent to other workstations and, if yes, to which workstations. The detection of a parameter type selection signal and the display of the control parameters belonging to the specific parameter type dependent on this parameter type selection signal ensures that the control parameters are offered for modification, which control parameters are grouped sensibly (according to a selection possibility hierarchically pre-set in the menu), again for a significantly improved overview for the operator.

In the cases in which a parameter type comprises the control parameters of a scan process and/or image reconstruction process to be implemented with an imaging medical-technical system, a scan mode selection signal is advantageously detected for further selection, i.e. limitation of process control protocols with regard to which the modification actions are to be implemented. Using this scan mode selection signal such process control protocols are then selected with which an activation of the medical-technical system ensues in a determined scan mode. This means that a further selection with regard to the scan mode ensues again from the previously-selected process control protocols. For example, given a computer tomograph there are two different fundamental acquisition methods. In a first method (which is known as a “sequential scan”) the gantry of the computer tomograph travels around the patient in a revolution plane for acquisition of a specific slice. The tomograph and patient are subsequently displaced by a short distance relative to one another and perpendicular to the revolution plane and a new revolution then ensues. In a second fundamental method (what is known as the “spiral scan”) the gantry runs in a spiral around the patient. Before the modification of control parameters the operator can then determine again whether the subsequent modifications should concern all previously-selected process control protocols, only the process control protocols which pertain to a sequential scan or only those process control protocols which pertain to a spiral scan.

In order to avoid that an operator inputs an unacceptable control parameter value, in a preferred variant at least one allowable value range of the appertaining control parameter is displayed to the operator for input of control parameters when the operator inputs an unacceptable value. A corresponding acoustic and/or optical warning (for example via marking of the field in which the operator has input the unacceptable value) additionally preferably ensues. In an alternative exemplary embodiment, a corresponding acoustic and/or optical instruction likewise ensues and the maximum allowable value is automatically adopted given a too-high value and the minimal allowable value is automatically adopted given a too-low value.

Furthermore, in a particularly preferred method a relative parameter modification value (for example in percent or in fractions) is detected for a modifiable control parameter. A control parameter value belonging to this control parameter can then be modified relative to the currently applied value according to the parameter modification value. In many cases this is particularly easily understood by the user, in particular given modifications of the dose. Here the operator would often simply like to specify that the dose should be reduced by a specific percentile, for example 10%. It is no longer necessary like before that the operator calculates the new control parameter value from the current control parameter value and manually inputs this new control parameter value.

As already explained briefly, various modification actions can be selected in the framework of the inventive method for modification of a set of defined process control protocols.

One of these modification actions is advantageously a modification of control parameter values in a number of process control protocols. This method workflow was already described in detail above.

A further modification action advantageously comprises a resorting of a display order of process control protocols within the set of defined process control protocols. Various operations normally preferably operate with specific protocols. For the operator it is then advantageous when these preferred process control protocols are, for example, always displayed first for selection for a modification or for selection for a subsequent examination.

A different modification action advantageously comprises a reestablishment or resetting of predetermined standard process control protocols. The default protocols, which are those that are set at the factory, for example, of the system manufacturer and/or vendor can hereby be reestablished. In a preferred variant of the method it is thereby possible that a modified standard process control protocol is selectively (i.e. according to a corresponding selection by the operator) reset again to an original standard process control protocol or the original standard process control protocol is reestablished by leaving the modified standard process control protocol, such that then both the standard process control protocol and the modified standard process control protocol are available.

Furthermore, one of the modification actions advantageously comprises an adoption of predefined process control protocols, meaning that, for example, further standard process control protocols are imported that are only generated after the delivery of such a medical system. This can, for example, ensue via a suitable network such as a telephone or Internet connection.

A further modification action advantageously comprises a deletion of process control protocols that are no longer required by the operator.

Both in the inventive method for modification of a number of process control protocols and in the superordinate method for modification of a set of defined process control protocols, given a particularly preferred variant the number of the method steps within a modification process to be run is shown to the operator. Moreover, it is then displayed in which of the method steps the modification process is currently located. This makes the orientation within the modification process significantly easier for the operator. In this case the operator advantageously also has the possibility to “jump back and forth” between various method steps, i.e. to directly activate specific method steps or to skip or jump back to a method step.

The process control protocols preferably serve for control or activation of an imaging medical-technical system. In principle, however, the invention can also be used for modification of process control protocols or, respectively, sets of defined process control protocols which serve for control of other medical-technical systems, for example therapeutic systems.

In the subsequent exemplary embodiment described in detail, the invention is represented using what is known as a “scan protocol assistant” realized in the form of software. This “scan protocol assistant” thereby forms a user interface which enables a modification of parameters in individual process control protocols or in groups of process control protocols in an easy manner within an easily-followed dialog. In particular, whole sets of defined process control protocols can herewith also be modified. In the illustrated exemplary embodiment, the process control protocols are scan protocols for a computer tomograph. Ultimately the process control parameter values are thereby predetermined for a later measurement with the aid of the “scan protocol assistant” and the imaging system is consequently operated.

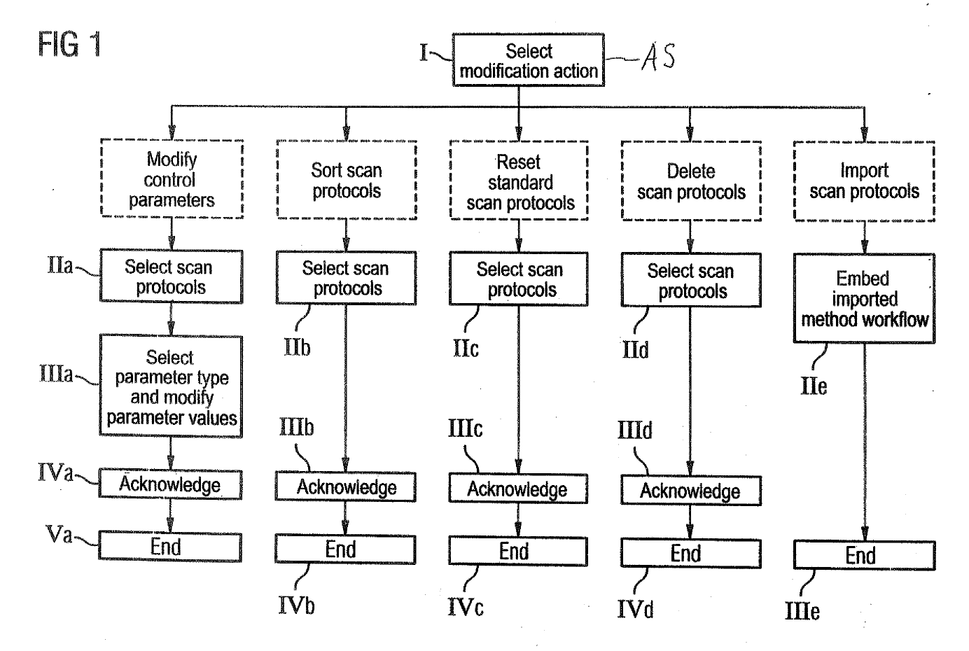

FIG. 1 shows the method workflow in overview. In a first step I, the user can select a specific modification action. For this an action selection signal AS is detected. The following modification actions are possible:
sorting in order of the scan protocols which respectively pertain to specific body regions, as shown in the second column (column b) of steps;
modifications of control parameters within the scan protocols, as shown in the first column (column a);
importation of new standard scan protocols from, for example, a CD or over the Internet, as shown in the fifth column (column e);
reestablishment or resetting of standard scan protocols, as shown in the third column (column c); and
deletion of scan protocols, as shown in the fourth column (column d).

Depending on the selected modification action, different modification processes are run through (i.e. different dialogs occur with the aid of corresponding dialog windows of the user interface). However, in most modification processes (with the exception of the import of new scan protocols), a selection of the scan protocols to be modified (steps IIa through He) always is performed first.

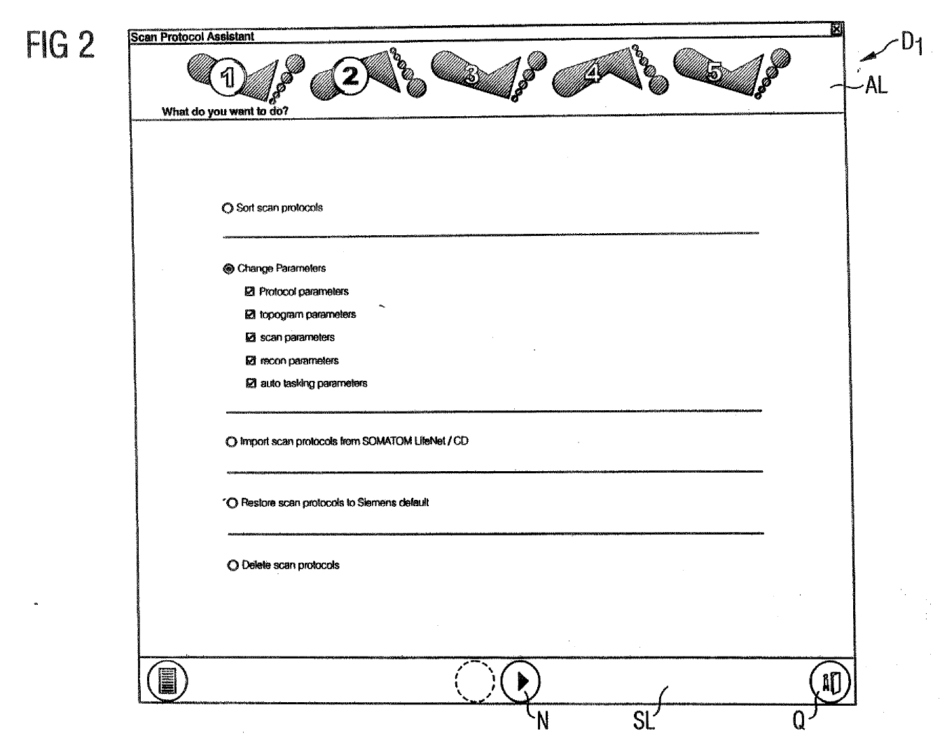

The most significant modification process is hereby the adjustment of individual control parameters in a scan protocol or a group of scan protocols process steps IIa through Va). An exemplary workflow of such a modification process is therefore described in the following using the dialog windows shown in FIGS. 2 through 10.

For implementation of the first step (corresponding to step I in FIG. 1), in a first dialog window D₁ (FIG. 2) it is specified by the user that the user would like to modify control parameters within the scan protocols (“change parameters”). This ensues via marking of the corresponding point in the dialog window D₁. The operator here simultaneously has the possibility to select which types of control parameters he or she would like to modify. Differentiation is thereby made according to protocol control parameters, topogram control parameters, scan control parameters, reconstruction control parameters and auto-tasking control parameters that are explained in detail in the following.

An action step bar AL is located above the input field at the upper edge of the dialog window. In the illustration, the steps are represented as footprints to indicate to the user that these are the steps to be taken in order, although other representations may also be provided. Using this action step bar AL, the user can detect that there are in total five different method steps (called “action steps” in the following) within the selected modification action in this modification process. It is thereby advantageously marked in an unambiguous manner which of the action steps is activated, i.e. in which action step the operator is presently located (this is the step number 1 in the example of the dialog window D1 shown in FIG. 2), which action steps can be activated (in the shown example this is the action step number 2) in that the operator calls one of these action steps (for example with a mouse click) and which action steps can currently not be activated (in the current exemplary embodiment these are the action steps number 3, number 4 and number 5). Instead of starting the action step number 2 by clicking on the action step bar AL with a mouse pointer or the like, the operator can also start the next action step by clicking on a forward button N in the switch bar SL at the lower edge of the dialog window D1. The operator can end the modification process again at any time via an end key button Q (“Quit” or exit).

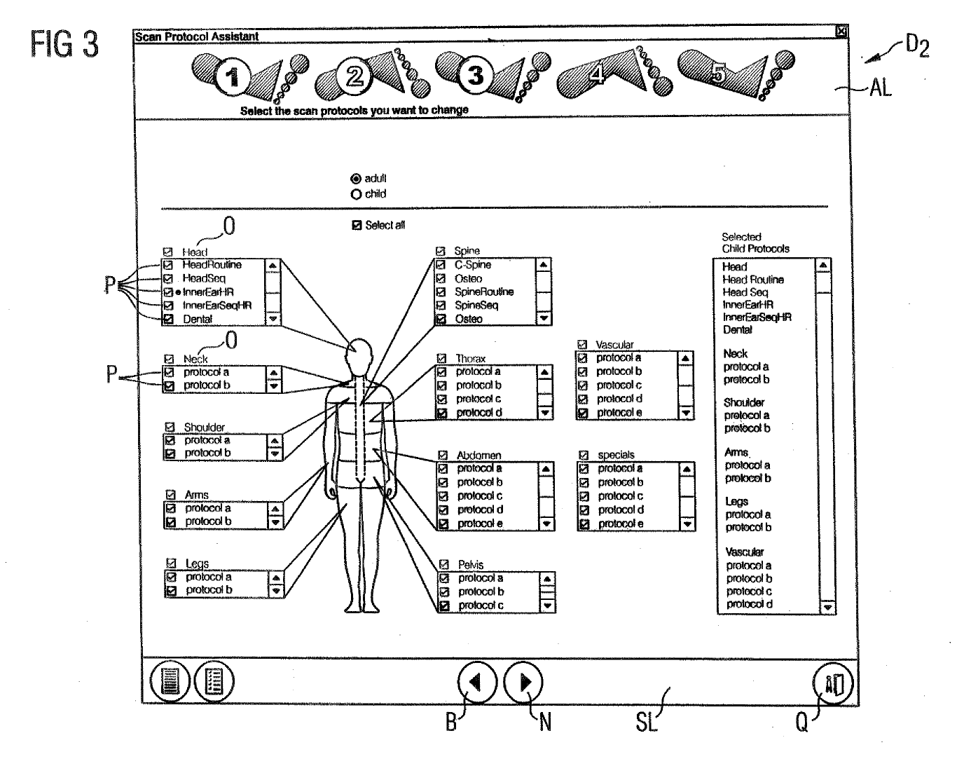

In the selection of the modification action “change parameters” shown in FIG. 2, the user then arrives at the second action step at the dialog window D2 as it is shown in FIG. 3. With the aid of this dialog window D₂ the user can select the protocols in which he would like to modify parameters. This corresponds to the step IIa in FIG. 1.

All process control protocols that are considered for an adult patient are displayed in the dialog window D₂. For this the various process control protocols P are associated with specific folders O that respectively represent a body part. By clicking on the folder O, all process control protocols P associated with this are also automatically selected. For better clarity, the folders O are respectively graphically linked with a representation of an adult patient. In addition to the representations of the parts of the patient with the associated folders, some of the folders O such as the “vascular” or “specials” folders are shown in the dialog window D₂ without an association to a particular body part. By marking the options “Adult” and “Child” the operator can switch between the displayed protocols for adult patients and protocols for pediatric patients. The operator can select all process control protocols at once via a further option point “select all”.

Moreover, a field with already-selected process control protocols is located on the right side of the dialog window D₂. In the exemplary embodiment shown in FIG. 3, the user has already selected various pediatric protocols in that he or she previously selected the corresponding window for children and there has selected specific process control protocols. Here as well the operator can again jump back to the preceding action step number 1 or start the next action step number 2 by clicking on the appertaining action steps on the action step bar AL. The same is also possible for the operator by clicking on the backward button B or the forward button N in the switch bar SL at the lower edge of the dialog window D₂. Here the operator can also abort the method via an end key Q. The backward button B, the forward button N and the end button Q in the switch bar SL are also present in the subsequently-described further dialog windows. Of course, the designations and representations of these keys may be varied without departing from the scope of the invention.

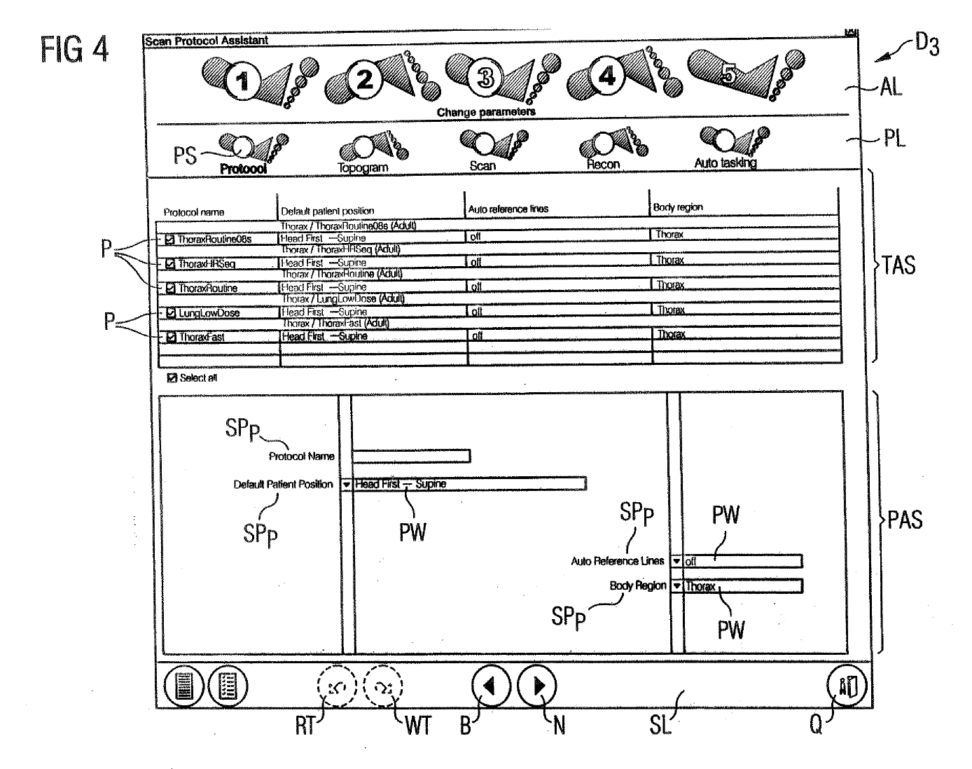

Given a jump to the action step number 3 (step IIIa in FIG. 1), the dialog window D₃ shown in FIG. 4 (for example) then opens automatically. Located here under the action step bar AL is initially a parameter type selection bar PL via which the user can select the respective parameter type whose associated control parameters are offered for modification in the parameter modification section PAS shown further below. The table section TAS in which the selected process control protocols are shown is located between the parameter type selection bar PL and the parameter modification section PAS, within which process control protocols the modifications should be implemented according to the specifications in the parameter modification section PAS.

In the exemplary embodiment shown in FIG. 4, the protocol control parameters SPP are selected as a control parameter type. Among other things, the protocol control parameters SPP can include the name of the protocol, the standard position of the patient in the scanner, a specification of whether auto-reference lines were involved and to which folder (i.e. to which body region (see dialog window D₂ in FIG. 3)). The input fields for the parameter values PW are respectively located after the protocol control parameters SPP, which parameter values PW can, for example, be changed via a corresponding mouse click on a switch located between the control parameters SPP and the associated input fields. Alternatively, given some control parameters, a desired parameter value PW can also be written directly into the appertaining input field.

All changes that are implemented in the parameter modification selection PSA are modified above in the table section TAS in the selected process control protocols. In the table section TAS, the operator can moreover implement a post-selection for this via clicking in front of the respective protocol name of the displayed process control protocols P. Via an additional option field he also has the possibility to select all process control protocols P displayed in the table section TAS and pre-selected in the action step number 2.

A “cancel button” RT and a “reset button” WT are additionally located in the switch bar SL at the lower portion of the dialog window D₃. By clicking on the cancel button RT the operator can cancel the last modifications; with the aid of the reset button WT the operator can reestablish a cancelled modification. For the operator the possibility of returning the settings to pervious values takes away the inhibition to test something and thus leads to the situation that even non-proficient operators can more easily familiarize themselves with the operating characteristics of the device and thus achieve optimal examination results in a short time. These buttons RT and WT are therefore advantageously present in all dialog windows in which the operator can change parameters. In the exemplary embodiment shown in FIG. 4, no parameters have yet been modified, such that the two buttons RT and WT cannot be activated.

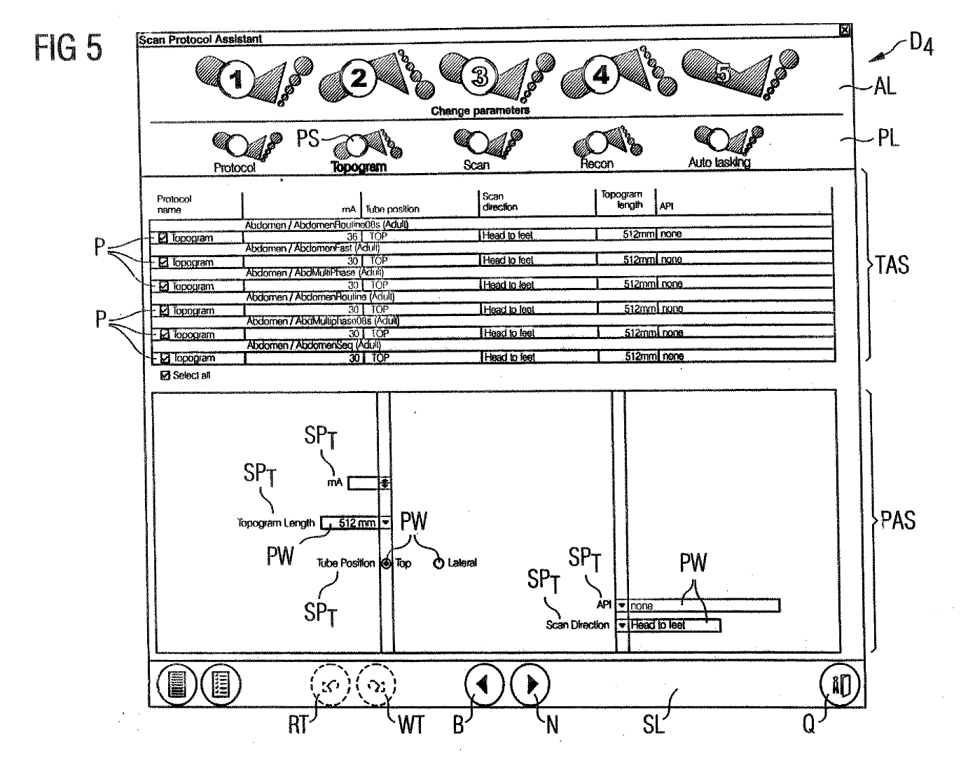

When the user selects the topogram control parameters SPT by clicking on the matching parameter type selection switch PS in the parameter type selection bar PL, the dialog window D₄ shown in FIG. 5 is thus automatically opened. This dialog window D₄ also again comprises an action step bar AL at the upper edge, below the action bar is the parameter type selection bar PL, then a table section TAS and under the table section is the parameter modification section PAS. Here the topogram control parameters SPT that are required for the generation of a topogram (i.e. of a CT (computer tomography) overview image) are shown here in the parameter modification section PAS. The switch bar SL with whose help the operator can alternatively change to another action step or end the method by clicking on the action steps in the action step bar AL is again located at the lower end of the dialog window D₄.

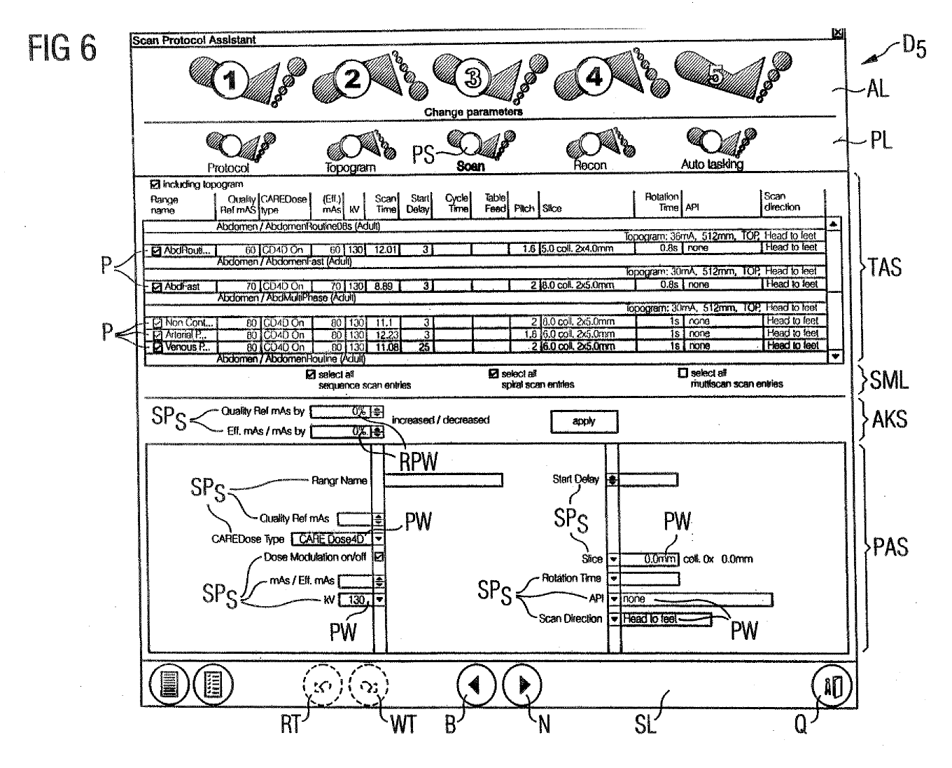

The dialog window D₅ shown in FIG. 6 appears upon clicking on the parameter type selection switch PS “Scan” in the parameter type selection bar PL. This dialog window D₅ also again has at the upper edge an action step bar AL, below this is the parameter type selection bar PL and then a table section TAS. Located again at the lower edge of the window are the switch bar SL and above this the parameter modification section PAS in which the scan control parameters SPS are displayed.

An action section AKS and a scan mode selection bar SML are additionally located in this dialog window D₅ between the table section TAS and the parameter modification section PAS.

In the scan mode selection bar SML portion of the display the operator can predetermine in which of the process control protocols actual modifications of the scan control parameters SPS should be implemented, which process control protocols are selected above in the dialog window D₂ (see FIG. 3) within the action step number 2 and displayed in the table section TAS. All displayed protocols are selected by marking the option “select all”. By marking the option “select all sequence scan entries”, only the process control protocols are selected that pertain to a sequential scan. All of the process control protocols that pertain to a spiral scan are selected by marking the option “select all spiral scan entries”. Corresponding scan mode selection signals are generated by marking the respective option.

In the action section AKS, the operator can specify a relative parameter modification value in percent instead of an absolute input for specific scan control parameters SPS. In the exemplary embodiment shown in FIG. 6 he can make this specification for the dose, either in the form of the quality reference value (Quality ref.) or in the form of an effective dose (Eff.). The dose specification in the form of a quality reference value can then be used when, for example, a specific dose automation (called “CAREDose”) is activated. Given activation of this option the matching dose values are also automatically calculated at each location dependent on the predetermined quality reference value and the body thickness of the patient. If this dose automatism (automatic dosing) is deactivated, the specification of the effective dose instead applies for the entire measurement region. The dose automatism can be set via the scan control parameter “CAREDose Type” that is likewise specified here in the parameter modification section. Via the action switch “apply” in the action section AKS it can be determined whether the relative parameter modification value RPW or an absolute parameter value should be adopted. The last absolute value to be adopted is displayed in the corresponding column in the table section TAS in the rows belonging to the selected protocols P.

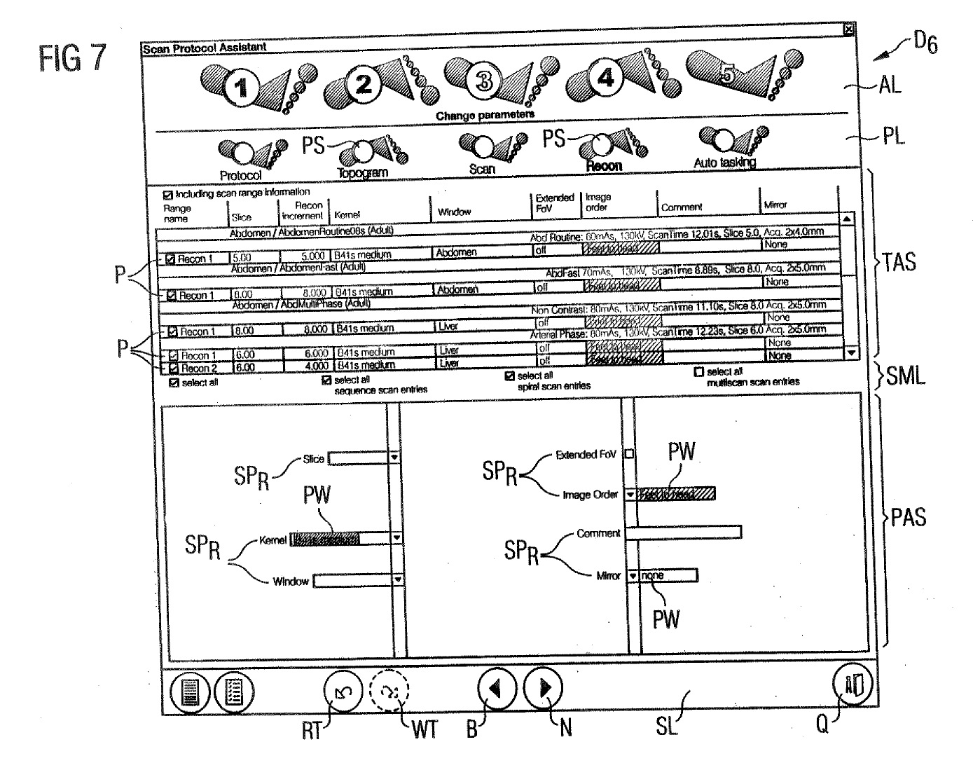

FIG. 7 shows a further dialog window D₆ for the modification of the reconstruction control parameters SPR required for the image reconstruction. In order to arrive at this dialog window D₆, the operator must activate the parameter type selection switch PS “Recon” in the parameter type selection bar PL. Apart from the action section AKS, the dialog window D₆ is again designed in the same manner as the dialog window D₅ for the scan control parameters SPS. However, in this image it is shown that a parameter value PW was already modified, namely here the parameter value PW “Feet to Head” of the reconstruction control parameter SPR “Image Order” which specifies in which order the images are to be reconstructed. This last modified parameter value PW is marked, for example via a color background. The values modified in the table section TAS in the various protocol rows are correspondingly marked in the same manner.

Since a parameter was already altered in the exemplary embodiment shown in FIG. 7, the cancel button RT can now also be activated. If the cancel button RT was activated, the reset button WT can correspondingly also be activated.

In the event that a parameter value is selected that lies outside of the allowable value range of the appertaining control parameter SPP, SPT, SPS, SPR, SPA, this is advantageously marked in a different color and the value is set to the maximum allowable value insofar as it is too high or set to a minimum if the value is too low. Alternatively, given such an incorrect input the entire allowable range can be clearly displayed so that the user can then select a new value within the range.

Via an option “Including Scan Range Information” at the left upper edge of the table selection section TAS, it can be established whether the information about the respective “scan range” belonging to the process control protocol P is specified as well within the table selection section TAS.

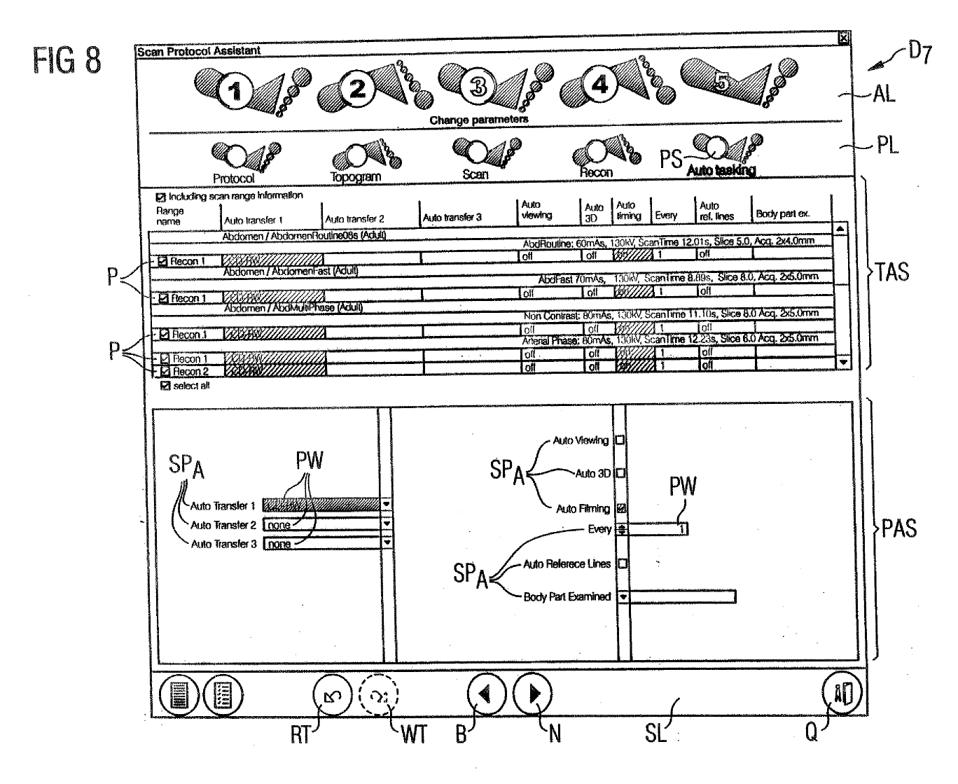

FIG. 8 shows a dialog window D₇ which is displayed in order to modify the auto-tasking control parameters SPA. These auto-tasking control parameters SPA establish what matches with the reconstructed images, for example whether an automatic transfer (“Auto transfer”) to specific apparatuses ensues and, if yes, to which apparatuses. It can also be established whether an automatic filming ensues or not. The last two parameters have already been modified in the exemplary embodiment shown in FIG. 8 and are therefore marked both in the parameter modification section PAS and in the table section TAS.

As soon as the operator has modified all desired control parameters SPP, SPT, SPS, SPR, SPA for the selected process control protocols P, the operator can start the next action step either by clicking the button of the corresponding fourth action step with the mouse pointer in the action step bar AL or by clicking on the forwards button N in the switch bar SL at the lower edge of the dialog window.

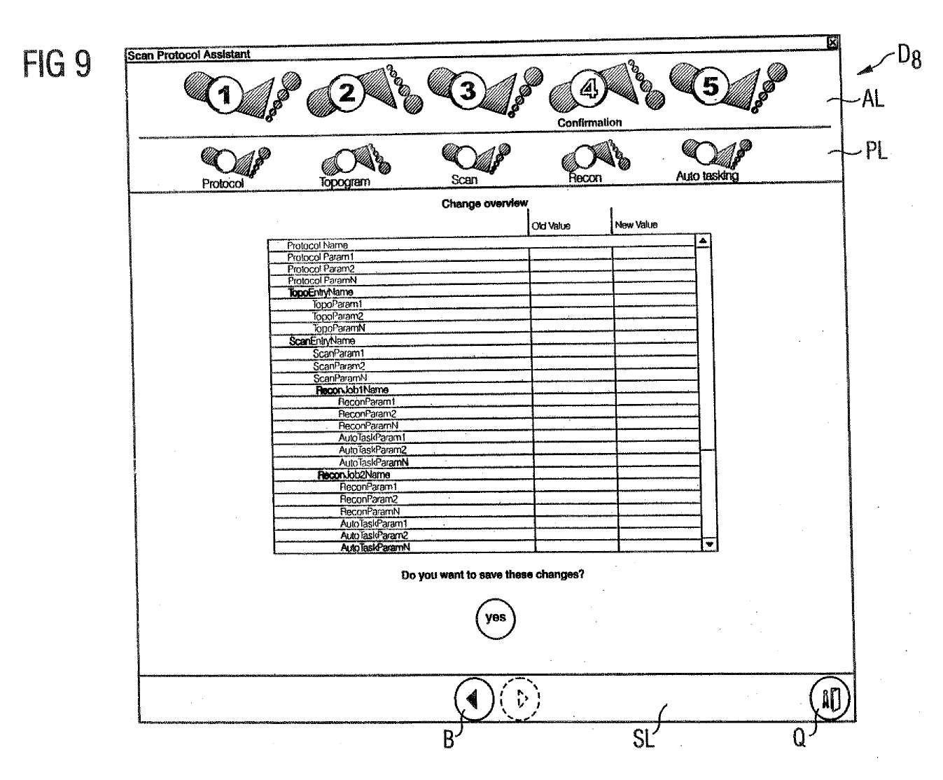

Ah acknowledgement dialog window Ds (see FIG. 9) is shown in an action step number 4. This step is shown in FIG. 1 as step IVa. Apart from an import of new standard protocols, such a dialog window D₈ is called in all other modification processes in the last method step IIIb, IIIc, IIId before the conclusion of the modifications. In this acknowledgement dialog window D₈ the operator receives in an overview window an overview of all selected, modified process control protocols P as well as the parameters modified in the respective protocols. The old parameter value (“Old Value”) and the new parameter value (“Sew Value”) are thereby respectively compared. The operator then has the possioility to check all implemented modifications again and can subsequently generate a corresponding acknowledgement signal by clicking on the button “Yes” under the overview window, such that the modifications are automatically adopted into the process control protocols.

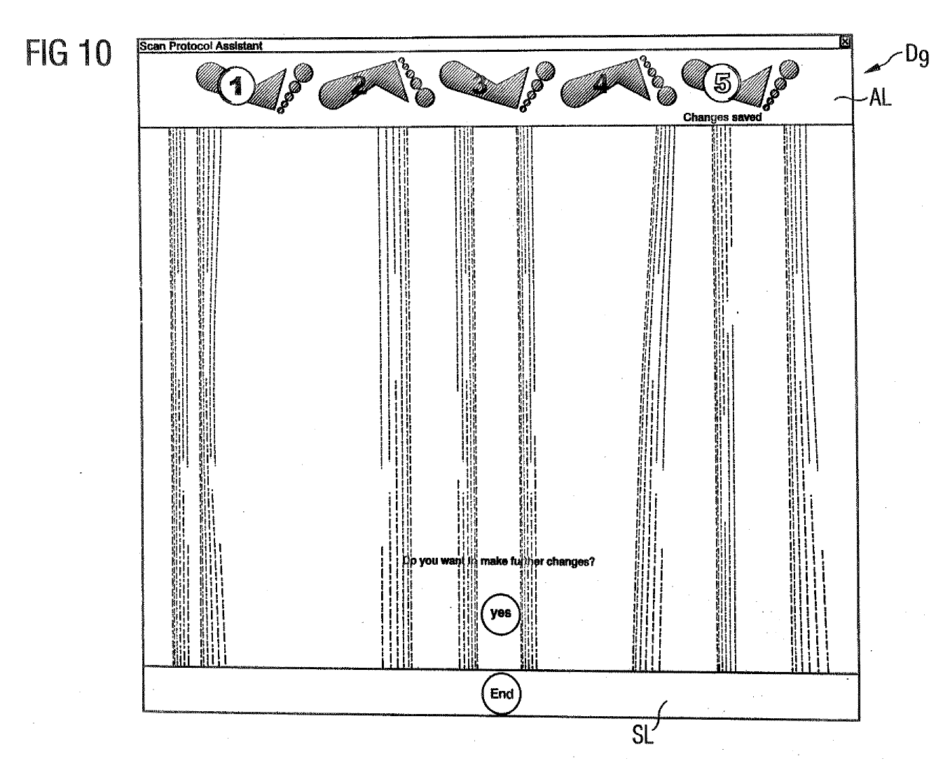

The actual adoption or, respectively, storage of the modifications ensues via clicking on the button “Yes”. At the start of the action step number 5 (step Va in FIG. 1) (a corresponding dialog window D₉ is shown in FIG. 10) the user can specify whether to effect further modifications or terminate the method entirely. The modification process for implementation of individual parameter values in a process control protocol or a group of process control protocols is then ended with the dialog window D₉.

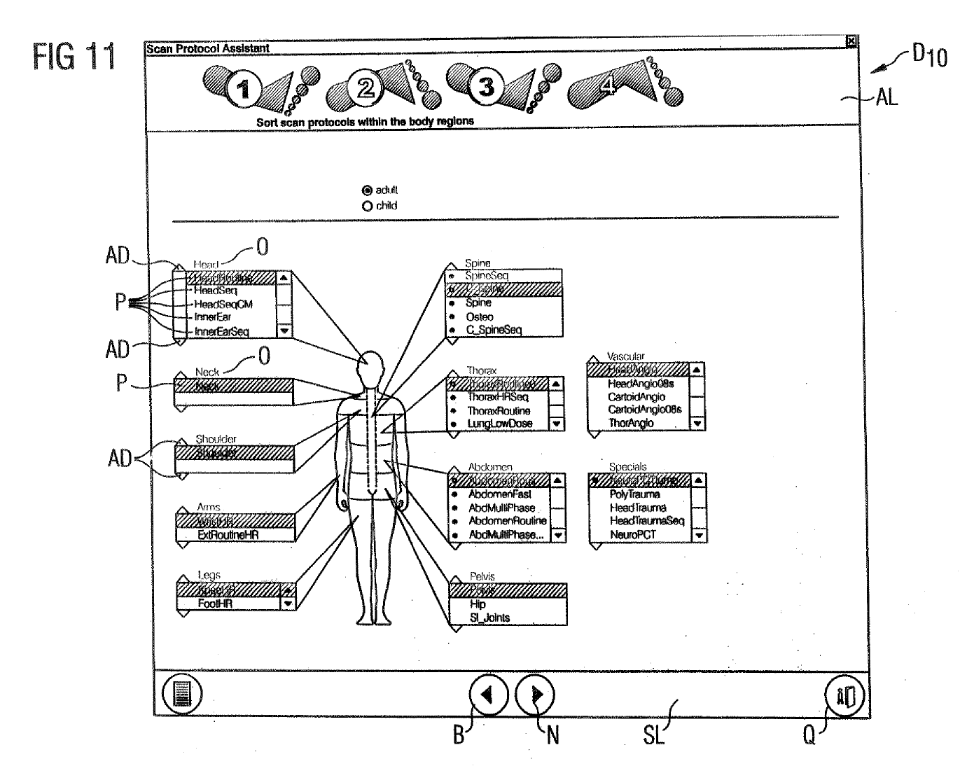

FIG. 11 shows a dialog window D₉ which is invoked first when the user has decided in the dialog window D₁ (see FIG. 1) to select the option “Sort Scan Protocol” in order to change the order of the display of process control protocols.

Here again as well there is the option to have displayed the process control protocols for adults or for children. The individual folders O of the process control protocols P are respectively displayed. The user can then sort the available process control protocols P within these folders O in that the user clicks on the name of the respective process control protocol P and then clicks on an action triangle AD arranged at the left side at the upper or lower edge of the folder window in order to shift the marked process control protocol P upward or downward in the order. This option is provided since specific operators prefer specific process control protocols and it is therefore more advantageous for them when the process control protocols P preferred by them are displayed at the beginning of the folder O. The order input in this mode determines for example, the order in which the individual process control protocols P are displayed given the selection of process control protocols P for modification of the control parameters that are displayed in the folders O (see dialog window D₂ in FIG. 3). The action step number 3 (step IIb in FIG. 1) in this scan parameter modification process is then again an acknowledgement window. A dialog window similar to the dialog window D₉ in FIG. 10 is subsequently displayed in the action step number 4 (in a step IVb according to FIG. 1).

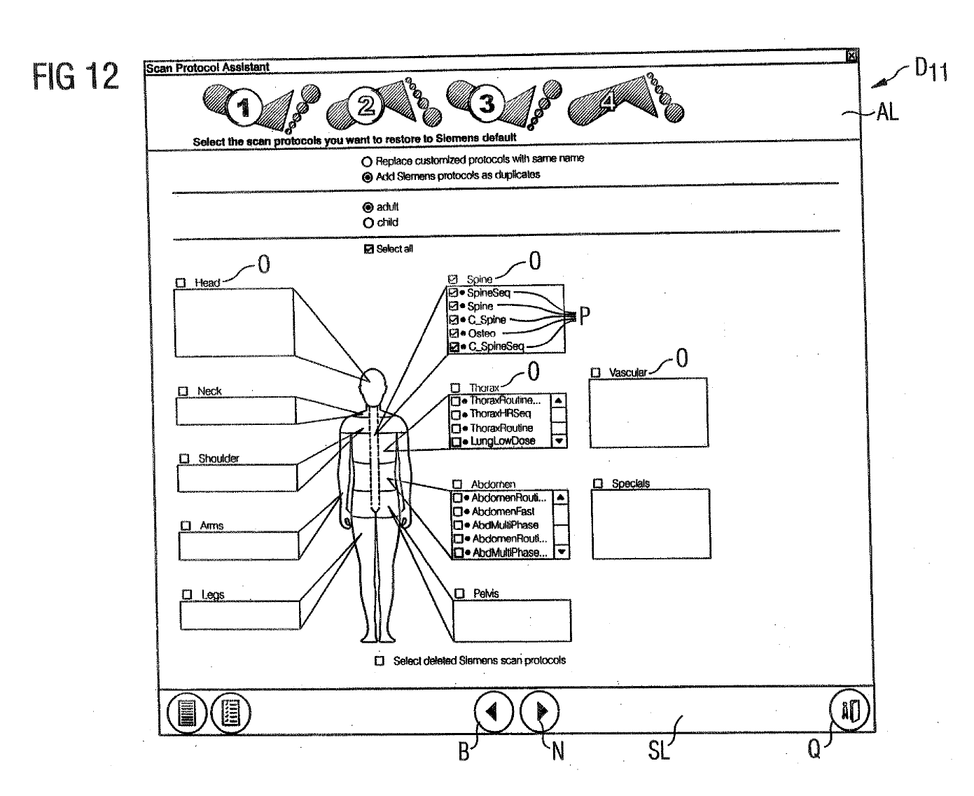

FIG. 12 shows a dialog window D₁₁ that is displayed in the method step number 2 (step IIc in FIG. 1), i.e. when the user would like to reestablish standard scan protocols. An action step bar AL is again located in the upper region of this window. Below this the operator can specify whether to overwrite the protocols modified by the operator again or whether the operator would like to add to the standard protocols as duplicates. Furthermore the operator can select whether these are protocols for adults or for children. In the selection field located below this the operator can then select the process control protocols P for which a reestablishment of the standard protocols should ensue. Here only the process control protocols P that were also already modified (i.e. in which the standard protocols are not already present anyway) can be selected.

An acknowledgement window in which the modifications are displayed is again called in a further action step number 3 (step IIIc in FIG. 1) and a termination window corresponding to the dialog window Dg in FIG. 10 is called in the action step number 4 (step IVc in FIG. 1).

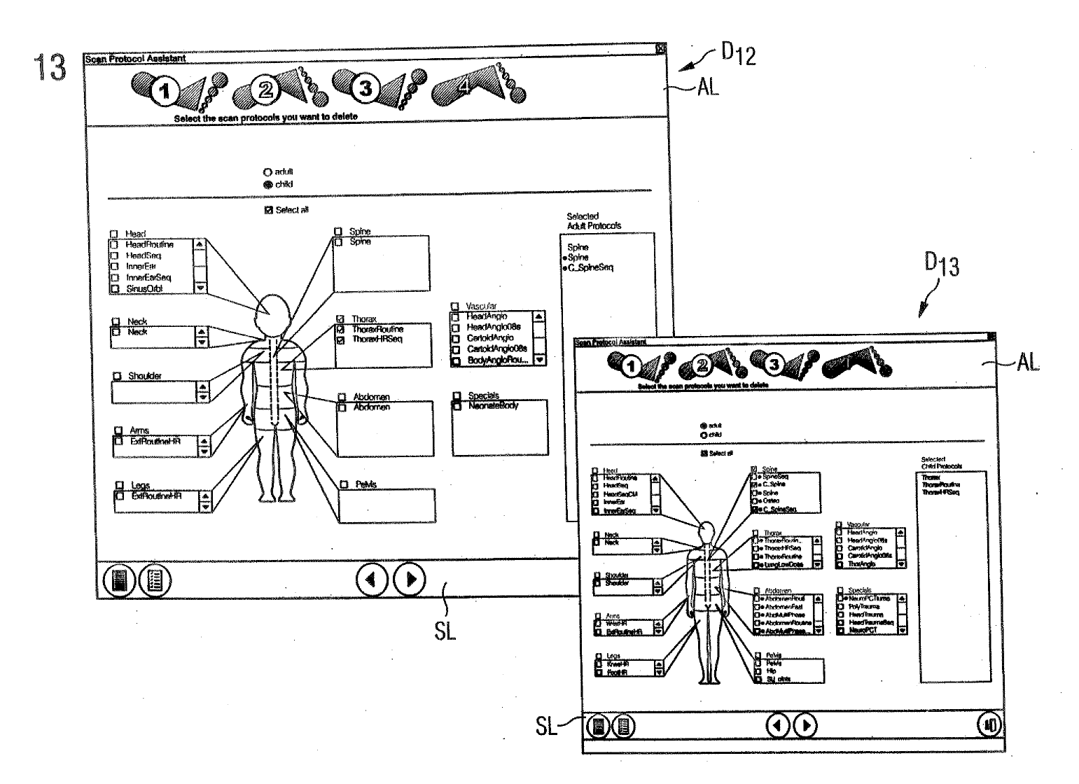

FIG. 13 shows two different dialog windows D₁₂ and D₁₃ which are displayed in the action step number 2 (step IId in FIG. 1) when the user would like to delete process control protocols P. The difference between a protocol selection window D₁₃ for adults and a protocol selection window D₁₂ for children is shown in this example. Which process control protocols have respectively already been selected is respectively displayed again in a separate field at the right edge of the window D₁₂ and D₁₃ when the user had previously selected protocols in the other window. This means that in the protocol selection window D₁₂ for the children it is displayed in this region which adult protocols have already been selected and in the protocol selection window D₁₃ for adults it is displayed which child protocols have already beer selected (if applicable). If the operator then goes to the action step number 3 (step IIId in FIG. 1), application protocols that the operator has provided for a deletion are thus displayed to him again. If the operator acknowledges the modifications there, these are deleted given selection of the action step number 4 (step IVd in FIG. 1) with display of a dialog window corresponding to the dialog window D₉ in FIG. 10.

As is visible from FIG. 1, it is also possible to import already-existing process control protocols over the Internet or CD. For this an already-existing process workflow with its own dialog windows is advantageously embedded within the shown scan protocol assistant (step IIe in FIG. 1). A protocol selection window is spared here since it does not concern already-present control protocols. However, a termination window similar to the dialog window D₉ in FIG. 10 is displayed again for termination in step IIIe.

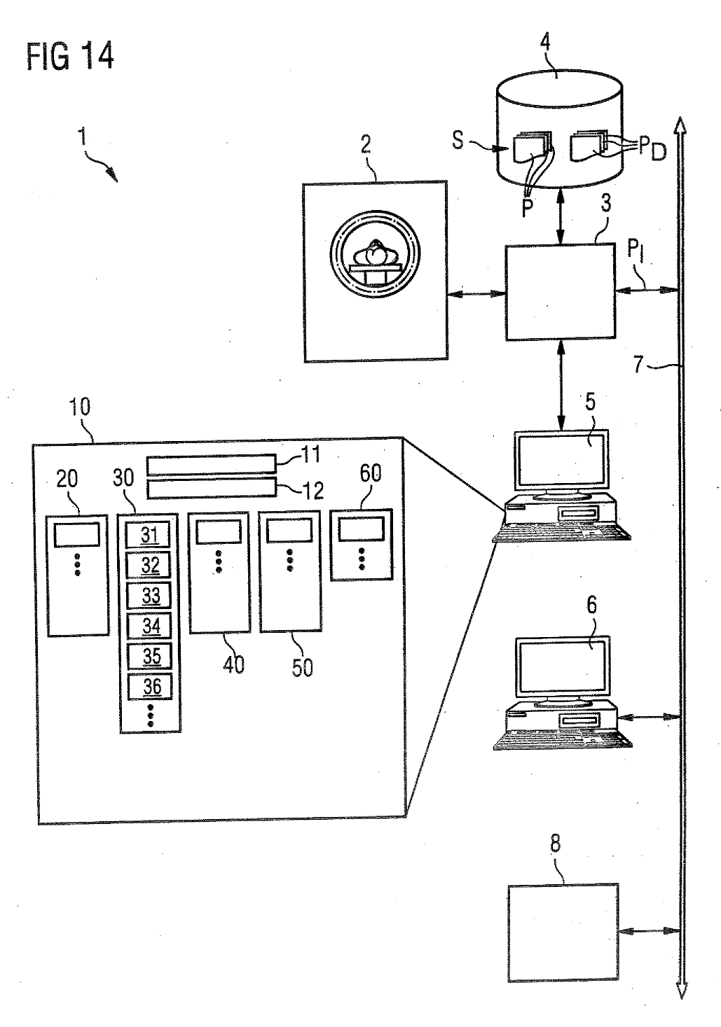

FIG. 14 shows a simple principle block diagram for an exemplary embodiment of a computer tomography system 1 with which the inventive method can be implemented. The core part of this computer tomography system 1 is the tomograph 2 (also called a scanner 2) in which a patient is borne on a bed within an annular gantry housing. The gantry with the x-ray source revolves in a known manner within this gantry housing. A detector system in order to acquire the raw image data in a typical manner is located on the other side of the x-ray source or annularly around the patient. The tomograph 2 is activated by a system controller 3 which here is shown as a separate block.

A mass storage 4 is connected to this system controller 3, in which mass storage 4 the generated images (among other things) can be stored. However, one set S or a plurality of sets of individual process control protocols P are also located in this mass storage 4. A number of standard protocols PD, also referred to as default protocols, that have been predetermined at the factory are among these.

Furthermore, a terminal 5 for operation of the system controller is connected to the system controller 3,

Moreover, the system controller 3 is connected to a bus system 7 to which further workstations 6 (for example monitoring stations) or other apparatuses (such as filming stations S) are connected. Image data, patient data or also process control protocols P and PD can be transmitted to the other apparatuses via this bus system 7. Via such a bus system 7 it is also possible to, for example, import further process control protocols PI via an Internet connection.

Like the design of the scanner 2 itself the design of such a system controller 3 as well as of the terminal 5 necessary for operation of the process controller 3 is known to the average man skilled in the art and does not need to be explained further here. The system controller 3 and the terminal 5 can also be integrated into a common device or even into the scanner 2. The system controller 3 can also comprise a plurality of components connected among one another.

According to aspects of the invention, a protocol set modification device 10 (which here is explicitly shown in the form of function blocks) is located on a computer unit of the terminal 5 or within the system controller 3. This protocol set modification device 10 is advantageously implemented in the form of suitable software components on one or more networked processors within the terminal computer 5 and/or the system controller 3. In principle such a protocol set modification device 10 can, however, also be implemented on an external computer (for example the workstation 6). Process control protocols P or, respectively, protocol sets S can then be modified on such a workstation 6 and the modified process control protocols P or, respectively, protocol sets S can then be sent to the system controller 3 of a scanner 2 or, respectively, be stored in an associated storage 4.

The protocol set modification device 10 comprises on the one hand a number of modification process implementation modules 20, 30, 40, 50, 60 as sub-modules. A specific modification process is associated with each of these modification process implementation modules 2, 30, 40, 50 and 60. Each of the modification process implementation modules 20, 30, 40, 50 and 6 thereby again comprises a number of sub-modules.

In the example shown in FIG. 14 there is provided a modification process implementation module 30 in order to change control parameter values in individual process control protocols P or in groups of process control protocols P. A further modification process implementation module 20 is designated to sort the output of the process control protocols P. A third modification process implementation module 40 serves to reestablish standard process control protocols. A fourth modification process implementation module 50 serves to delete process control protocols and a fifth modification process implementation module 60 serves to import process control protocols PI.

Moreover, the protocol set modification device 10 comprises an action selection detection module 11 which serves to detect an action selection signal (see FIG. 1) for selection of a specific modification action. Such an action selection detection module 11 provides, for example, for a display of the dialog window D1 (FIG. 2) and then detects the entries that the user makes in this dialog window D₁, i.e. which of the offered options the operator marks.

The detected action selection signals AS are then passed to a process selection module 12 which selects and starts the corresponding modification process implementation module 20, 30, 40, 50 and 60 from the present modification process implementation module 20, 30, 40, 50 and 60 dependent on the selected modification action. This means that the process selection module 12 ensues that the corresponding further dialog windows are called dependent on the selection of the user.

As mentioned, one of the modification process implementation modules 30 is fashioned such that the user can modify the control parameters PW in individual scan protocols P or groups of scan protocols P. This process was already described in detail using FIGS. 1 through 10. This means that such a modification process implementation module 30 corresponds to an inventive protocol modification unit 30.

As shown here this protocol modification unit 30 comprises a protocol selection detection module 31. This provides for a display of the dialog window D₂ shown in FIG. 3 in which the user can select a number of process control protocols P with regard to which the modifications are to be implemented. Moreover, the protocol modification unit 30 comprises a first display module 32. This is designated to display control parameters SPP, SPT, SPS, SPR and SPA that can be modified in the selected process control protocols P. This means that this display module provides that a display of dialog windows D₃, D₄, D₅, D₆ and D₇ ensues as they are shown in FIGS. 4 through 8. A parameter value detection module 33 then detects the parameter values PW as they are input by the user in the windows D₃, D₄, D₅, D₆, D₇. The modifications to be implemented in the selected process control protocols within the modification process are then displayed again with the aid of a second display module 34. This ensues, for example, in that the display module 34 provides for a display of the dialog window Ds as it is shown in FIG. 9. The acknowledgement signal is subsequently detected by an acknowledgement signal detection module 35 when the user clicks on the action button “Yes”⁵ below the modification list in the dialog window D₈. A modification process implementation module 36 finally automatically provides that the modifications in the selected process control protocols are automatically stored.

As is easily apparent in the example described above, with the aid of the invention the user has the possibility to implement all necessary modifications to arbitrary process control protocols (in particular scan protocols) himself or herself in an intuitive manner. The application trainers who typically adapt the scan protocols to the requirements of the hospital or, respectively, the respective practice in the orientation to the apparatus thereby save a great deal of time. Groups of scan protocols can thereby be changed at once in a clear manner. Input errors are avoided via the user direction and the representation on the user interface.

The result of the present method and apparatus is that the operation of the medical-technical apparatus may be changed and controlled to provide different operation of the device and different test results, for example.

In closing, it is again noted that the preceding method described in detail as well as the shown computer tomography measurement system are merely exemplary embodiments which can be modified in the most varied manner by the average man skilled in the art without leaving the scope of the invention. For example, the most varied functions and modules can be added. One possibility is, for example, the export of all existing or selected process control protocols in a list format such as Excel or also the display of an overview list of all or selected process control protocols. In principle the inventive principle for modification of the control protocols can be arbitrarily applied and expanded on all imaging apparatus types and applications. It thus represents a solid, stable platform for future application developments.

Although other modifications and changes may be suggested by those skilled in the art, it is the intention of the inventors to embody within the patent warranted hereon all changes and modifications as reasonably and properly come within the scope of their contribution to the art.

We claim:

1. A method for modification of a number of process control protocols of a set of defined process control protocols, comprising the steps of:
detecting protocol selection signals for selection of a number of process control protocols with regard to which a modification action is to be implemented;
displaying control parameters that can be changed in the selected process control protocols;
detecting parameter values according to which the control parameters are to be changed in the selected process control protocols;
displaying the changes to be implemented in the selected process control protocols within the modification action; and
detecting an acknowledgement signal and automatically implementing the changes the selected process control protocols when a corresponding acknowledgement signal is detected.

2. A method as claimed in claim 1, wherein said process control protocols serve for control of a medical-technical system for implementing examination processes.

3. A method according to claim 1, further comprising the steps of:
initially detecting a parameter type selection signal for detection of the parameter values; and
offering the control parameters belonging to a specific parameter type to an operator for modification dependent on a detection of the parameter type selection signal.

4. A method according to claim 1, wherein a parameter type includes the control parameters of at least one of a scan process and image reconstruction process to be implemented with an imaging medical-technical system; and further comprising the steps of:
detecting a scan mode selection signal or selection of the process control protocols with regard to which the modification actions are to be implemented; and
activating the medical-technical system in a specific scan mode with the process control protocols.

5. A method according to claim 1, further comprising the steps of:
receiving an operator input from an operator of a value of the control parameter; and
displaying to the operator an allowable value range for input of the control parameter values of the corresponding control parameter when the operator inputs an unacceptable value.

6. A method according to claim 1, further comprising the step of:
detecting a relative parameter modification value for a modifiable control parameter; and
permitting a control parameter value belonging to this control parameter to then be modified relative to the currently applied parameter value according to the parameter modification value.

7. A method for modification of a set of defined process control protocols which respectively serve for control of a medical-technical system for implementation of examination processes, further comprising the steps of:
initially detecting an action signal for selection of a specific modification action;
then selecting a modification process from a number of predefined modification processes;
initiating a workflow of the selected modification process; and
detecting further modification specification signals within the modification process; according to which modification specification signals the modifications are implemented.

8. A method according to claim 7, wherein a modification action comprises a modification of control parameter values in a number of process control protocols and the modifications are implemented within a modification process according to the following steps:
detecting protocol selection signals for selection of a number of process control protocols with regard to which a modification action is to be implemented;
displaying control parameters that can be changed in the selected process control protocols;
detecting parameter values according to which the control parameters are to be changed in the selected process control protocols;
displaying the changes to be implemented in the selected process control protocols within the modification action; and
detecting an acknowledgement signal and automatically implementing the changes the selected process control protocols when a corresponding acknowledgement signal is detected.

9. A method according to claim 7, wherein the modification action includes resorting of a display order of process control protocols within the set of defined process control protocols.

10. A method according to claim 7, wherein the modification action includes reestablishment of predetermined standard process control protocols.

11. A method according to claim 10, further comprising the step of: resetting a modified standard process control protocol to an original standard process control protocol.

12. A method as claimed in claim 10, further comprising the step of: reestablishing an original standard process control protocol by leaving the modified standard process control protocol.

13. A method according to claim 7, wherein the modification action includes adopting of predefined process control protocols.

14. A method according to claim 7, wherein a modification action comprises a deletion of process control protocols.

15. A method according to claim 7, her comprising the step of:
displaying to the operator the number of the method steps within a modification process to be run; and
displaying in which of the method steps the modification process is currently located.

16. A method according to claim 7, wherein the process control protocols respectively serve for control of an imaging medical-technical system.

17. A protocol modification unit for modification of a number of process control protocols of a set of defined process control protocols within a defined modification process, the protocol modification unit comprising the following modules respectively connected in communication:
a protocol selection detection module that is constructed and operable to detect protocol selection signals for selection of a number of process control protocols with regard to which a modification action is to be implemented;
a first display module that is constructed and operable to display control parameters that can be modified in the selected process control protocols;
a parameter value detection module that is constructed and operable to detect parameter values according to which the control parameters are to be modified in the selected process control protocols;
a second display module that is constructed and operable to display modifications that are to be implemented in the selected process control protocols within the modification process;
an acknowledgement signal detection module that is constructed and operable to detect an acknowledgement signal; and
a modification implementation module that is constructed and operable to automatically implement the changes with regard to the selected process control protocols when the acknowledgement signal detection module detects an acknowledgement signal.

18. A protocol modification unit as claimed in claim 17, wherein said protocol modification unit is connected to control of a medical-technical system for implementation of an examination process.

19. A protocol set modification device for modification of a set of defined process control protocols which respectively serve for control of a medical-technical system for implementation of examination processes, comprising the following modules respectively connected in communication:
a number of modification process implementation modules that are respectively constructed and operable to implement a specific modification action within a defined modification process, further modification specification signals according to which the modification actions are implemented are detected within this modification process;
an action selection detection module that is constructed and operable to detect an action selection signal for selection of a specific modification action; and
a process selection module that is constructed and operable to select a modification process implementation module from the number of modification process implementation modules dependent on the selected modification action and to put said modification process implementation module into operation.

20. A protocol set modification device according to claim 19, wherein a modification process implementation module includes a protocol modification unit comprising the following modules respectively connected in communication;
a protocol selection detection module that is constructed and operable to detect protocol selection signals for selection of a number of process control protocols with regard to which a modification action is to be implemented;
a first display module that is constructed and operable to display control parameters that can be modified in the selected process control protocols;
a parameter value detection module that is constructed and operable to detect parameter values according to which the control parameters are to be modified in the selected process control protocols;
a second display module that is constructed and operable to display modifications that are to be implemented in the selected process control protocols within the modification process;
an acknowledgement signal detection module that is constructed and operable to detect an acknowledgement signal; and
a modification implementation module that is constructed and operable to automatically implement the changes with regard to the selected process control protocols when the acknowledgement signal detection module detects an acknowledgement signal.

21. A control device for a medical-technical system for generation of patient image data with a protocol modification unit, the protocol modification unit comprising the following modules respectively connected in communication:
a protocol selection detection module that is constructed and operable to detect protocol selection signals for selection of a number of process control protocols with regard to which a modification action is to be implemented;
a first display module that is constructed and operable to display control parameters that can be modified in the selected process control protocols;
a parameter value detection module that is constructed and operable to detect parameter values according to which the control parameters are to be modified in the selected process control protocols;
a second display module that is constructed and operable to display modifications that are to be implemented in the selected process control protocols within the modification process;
an acknowledgement signal detection module that is constructed and operable to detect an acknowledgement signal; and
a modification implementation module that is constructed and operable to automatically implement the changes with regard to the selected process control protocols when the acknowledgement signal detection module detects an acknowledgement signal.

22. A control device for a medical-technical system for generation of patient image data with a protocol set modification device for modification of a set of defined process control protocols which respectively serve for control of a medical-technical system for implementation of examination processes, comprising the following modules respectively connected in communication:
a number of modification process implementation modules that are respectively constructed and operable to implement a specific modification action within a defined modification process, her modification specification signals according to which the modification actions are implemented are detected within this modification process;
an action selection detection module that is constructed and operable to detect an action selection signal for selection of a specific modification action; and
a process selection module that is constructed and operable to select a modification process implementation module from the number of modification process implementation modules dependent on the selected modification action and to put said modification process implementation module into operation.

23. A medical-technical system for generation of patient image data with a control device for a medical-technical system for generation of patient image data with a protocol modification unit, the protocol modification unit comprising the following modules respectively connected in communication:
a protocol selection detection module that is constructed and operable to detect protocol selection signals for selection of a number of process control protocols with regard to which a modification action is to be implemented;
a first display module that is constructed and operable to display control parameters that can be modified in the selected process control protocols;
a parameter value detection module that is constructed and operable to detect parameter values according to which the control parameters are to be modified in the selected process control protocols;
a second display module that is constructed and operable to display modifications that are to be implemented in the selected process control protocols within the modification process;
an acknowledgement signal detection module that is constructed and operable to detect an acknowledgement signal; and
a modification implementation module that is constructed and operable to automatically implement the changes with regard to the selected process control protocols when the acknowledgement signal detection module detects an acknowledgement signal.

24. A medical-technical system for generation of patient image data with a control device for a medical-technical system for generation of patient image data with a protocol set modification device for modification of a set of defined process control protocols which respectively serve for control of a medical-technical system for implementation of examination processes, comprising the following modules respectively connected in communication:
a number of modification process implementation modules that are respectively constructed and operable to implement a specific modification action within a defined modification process, further modification specification signals according to which the modification actions are implemented are detected within this modification process;
an action selection detection module that is constructed and operable to detect an action selection signal for selection of a specific modification action; and
a process selection module that is constructed and operable to select a modification process implementation module from the number of modification process implementation modules dependent on the selected modification action and to put said modification process implementation module into operation.

25. A computer program product which can be directly loaded into a memory of a programmable computer, the program product having program code that when the program is executed on the computer executes the following method steps:
detecting protocol selection signals for selection of a number of process control protocols with regard to which a modification action is to be implemented;
displaying control parameters that can be changed in the selected process control protocols;
detecting parameter values according to which the control parameters are to be changed in the selected process control protocols;
displaying the changes to be implemented in the selected process control protocols within the modification action; and
detecting an acknowledgement signal and automatically implementing the changes the selected process control protocols when a corresponding acknowledgement signal is detected.
